(19) United States
(12) Patent Application Publication
(10) Pub. No.: US 2016/0069493 A1
(43) Pub. Date: Mar. 10, 2016

(54) PIPE-JUNCTION GATE SYSTEM AND METHOD

(71) Applicants: Michael Jon Leseth, San Clemente, CA (US); H Paul Saeger Raymond, Windermere, FL (US)

(72) Inventors: Michael Jon Leseth, San Clemente, CA (US); H Paul Saeger Raymond, Windermere, FL (US)

(21) Appl. No.: 14/846,014

(22) Filed: Sep. 4, 2015

Related U.S. Application Data
(60) Provisional application No. 62/046,015, filed on Sep. 4, 2014.

(51) Int. Cl. F16L 29/00; F16K 3/02

(52) U.S. Cl. CPC F16L 29/007; F16K 3/0218; F16K 3/0227

(57) ABSTRACT

A system may include a pipe-junction and a mating-surface carried by the pipe-junction. The system may also include a gate that engages the mating-surface, and the gate includes an exterior-portion and an interior-portion. The system may further include a retainer that secures the gate to the mating-surface during a pressure-test-stage.

### RELATED APPLICATION

This application is based upon, and claims priority from, co-pending Provisional Application No. 62/046,015, filed Sep. 4, 2014, the entire subject matter of which is incorporated herein by reference in its entirety. This application and the application identified above include identical inventorship and ownership.

### BACKGROUND

The disclosure relates to the field of pipe systems.

Generally, a run of two pipes can be joined by a pipe-coupler. A gate in piping can control the flow of a fluid through the pipe.

### SUMMARY

In one embodiment, a system may include a pipe-junction and a mating-surface carried by the pipe-junction. The system may also include a gate that engages the mating-surface, and the gate includes an exterior-portion and an interior-portion. The system may further include a retainer that secures the gate to the mating-surface during a pressure-test-stage.

The system of may additionally include a seal between the gate and the pipe-junction that fluid-proofs that interface. The system may also include a frangible joint between the exterior-portion and the interior-portion that enables removal of the interior-portion for a post-test-stage.

The retainer may be a band clamp, fastener, adhesive joint, threaded fastener, clasp, hinge, and/or pin and socket. The gate may not be positioned by any mechanical positioning device and is instead positioned within the mating-surface by a user's hand during positioning.

The seal may fluid-proof the interior-portion and mating-surface interface, and/or the exterior-portion and pipe-junction interface. The mating-surface may include a relief, an intermittent relief, a raised border, an intermittent raised border, and/or a combination of relief and raised border.

The retainer may seal the pipe-junction when the interior-portion is removed during a post-test-stage. The pipe-junction comprises a coupler and/or the gate is non-inflatable.

Another aspect is a method, which may comprise installing a pipe-junction including a mating-surface into a piping system. The method may also include positioning a gate to the mating-surface by hand not using any mechanical positioning device so the gate blocks fluid flow in the piping system. The method may further include securing the gate to the pipe-junction to run a pressure-test-stage on the piping system.

The method may additionally include removing an interior-portion of the gate to allow fluid flow in the piping system in a post-test-stage. The method may also include sealing the pipe-junction with an exterior-portion of the gate.

The method may further include fluid-proofing a gate and pipe-junction interface with a seal. The method may additionally include providing a frangible joint between the exterior-portion and the interior-portion that enables the interior-portion of the gate to be removed during the post-test-stage.

The method may also include using a retainer to secure the gate. The method may further include using a retainer to seal the pipe-junction from fluid flow outside of the pipe-junction.

The method may additionally include fluid-proofing via the seal an interior-portion and relief interface, and an exterior-portion and/or pipe-junction interface. The method may also include closing the sealed pipe-junction within a finished wall.

The method may further include opening the sealed pipe-junction to maintain the piping system, and/or run another pressure-test-stage after a later modification to the piping system. The method may additionally include making the pipe-junction's central section when the gate is positioned symmetrical. The method may also include making the gate non-inflatable, and/or the pipe-junction comprise a coupler.

### BRIEF DESCRIPTION OF THE DRAWINGS

FIG. 1 is a top-view illustration of a pipe-junction gate system in accordance with various embodiments.

FIG. 2 is a top-view illustration of the gate of FIG. 1.

FIG. 3 is a side-view illustration of an pipe-junction of FIG. 1.

FIG. 4 is a bottom-view illustration of the pipe-junction gate system of FIG. 1.

FIG. 5 is a flowchart illustrating method aspects according to various embodiments.

FIG. 6 is a flowchart illustrating method aspects according to the method of FIG. 5.

FIG. 7 is a flowchart illustrating method aspects according to the method of FIG. 6.

FIG. 8 is a flowchart illustrating method aspects according to the method of FIG. 5.

FIG. 9 is a flowchart illustrating method aspects according to the method of FIG. 6.

FIG. 10 is a flowchart illustrating method aspects according to the method of FIG. 5.

FIG. 11 is a flowchart illustrating method aspects according to the method of FIG. 7.

FIG. 12 is a flowchart illustrating method aspects according to the method of FIG. 8.

FIG. 13 is a flowchart illustrating method aspects according to the method of FIG. 7.

FIG. 14 is a flowchart illustrating method aspects according to the method of FIG. 7.

FIG. 15 is a flowchart illustrating method aspects according to the method of FIG. 5.

FIG. 16 is a flowchart illustrating method aspects according to the method of FIG. 5.

FIG. 17 is an illustration of a pipe-junction gate system in accordance with various embodiments.

FIG. 18 is an illustration of a pipe-junction gate system in accordance with various embodiments.

FIG. 19 is an illustration of a pipe-junction gate system in accordance with various embodiments.

FIG. 20 is an illustration of a pipe-junction gate system with insert integrated into top piece, to be snapped off or otherwise removed after leak testing.

FIG. 21 is an illustration of a pipe-junction gate system in accordance with various embodiments.

FIG. 22 is an illustration of a pipe-junction gate system in accordance with various embodiments.

FIG. 23 is an illustration of a pipe-junction gate system in accordance with various embodiments.

FIG. 24 is an illustration of a pipe-junction gate system in accordance with various embodiments.

FIG. 25 is an illustration of a pipe-junction gate system in accordance with various embodiments.

FIG. 26 is an illustration of a pipe-junction gate system in accordance with various embodiments.

FIG. 27 is an illustration of a pipe-junction gate system in accordance with various embodiments.

FIG. 28 is an illustration of a pipe-junction gate system in accordance with various embodiments.

FIG. 29 is an illustration of a pipe-junction gate system in accordance with various embodiments.

FIG. 30 is an illustration of a pipe-junction gate system in accordance with various embodiments.

### DETAILED DESCRIPTION

Embodiments will now be described more fully hereinafter with reference to the accompanying drawings, in which preferred embodiments are shown. Like numbers refer to like elements throughout.

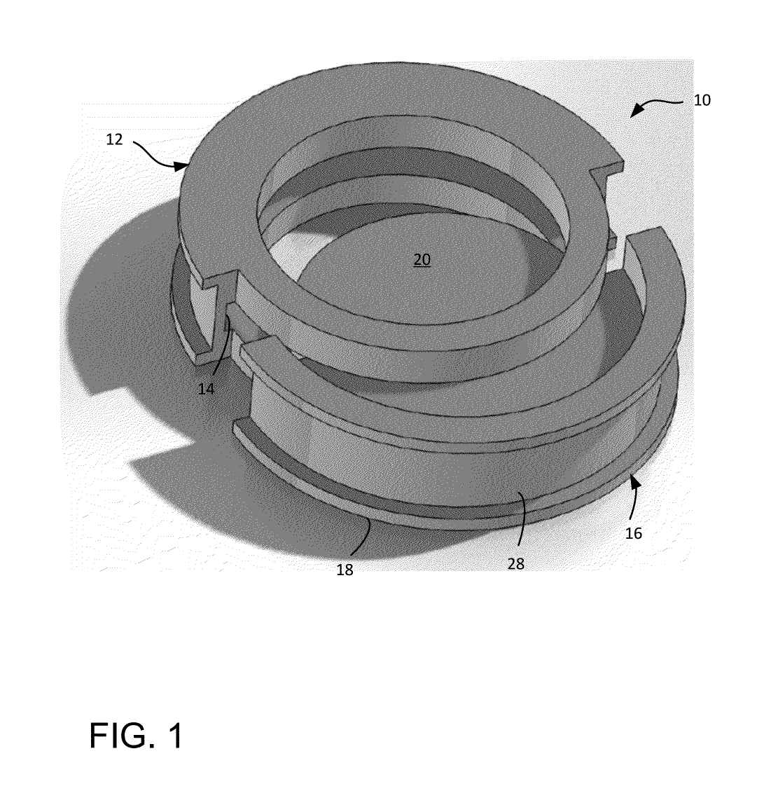

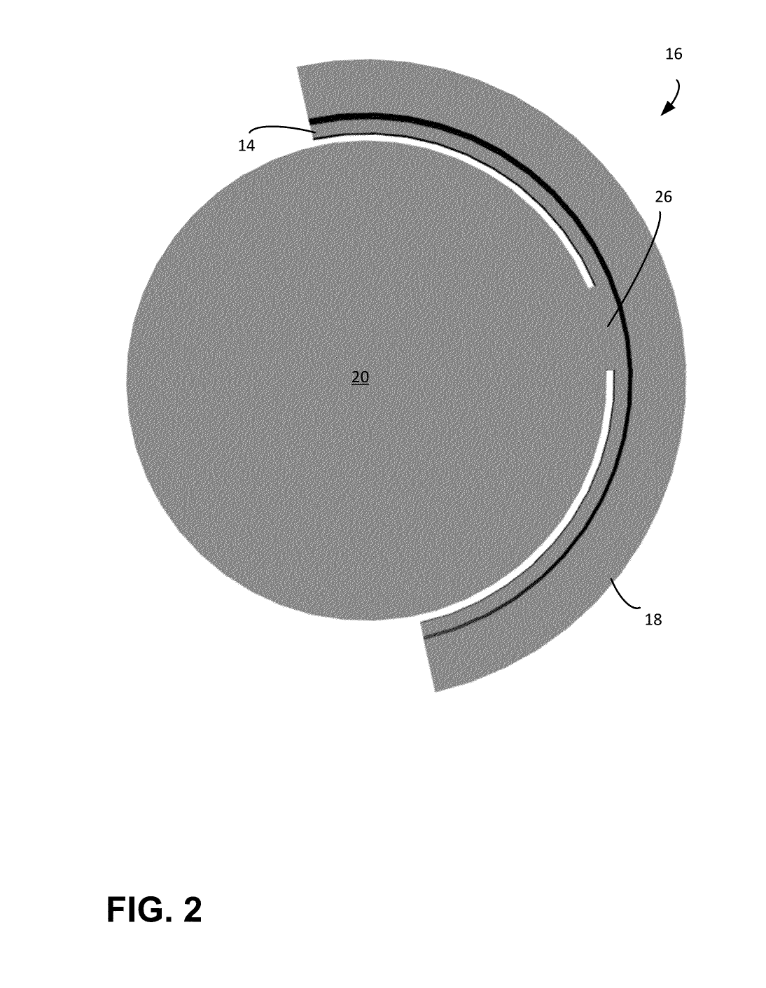

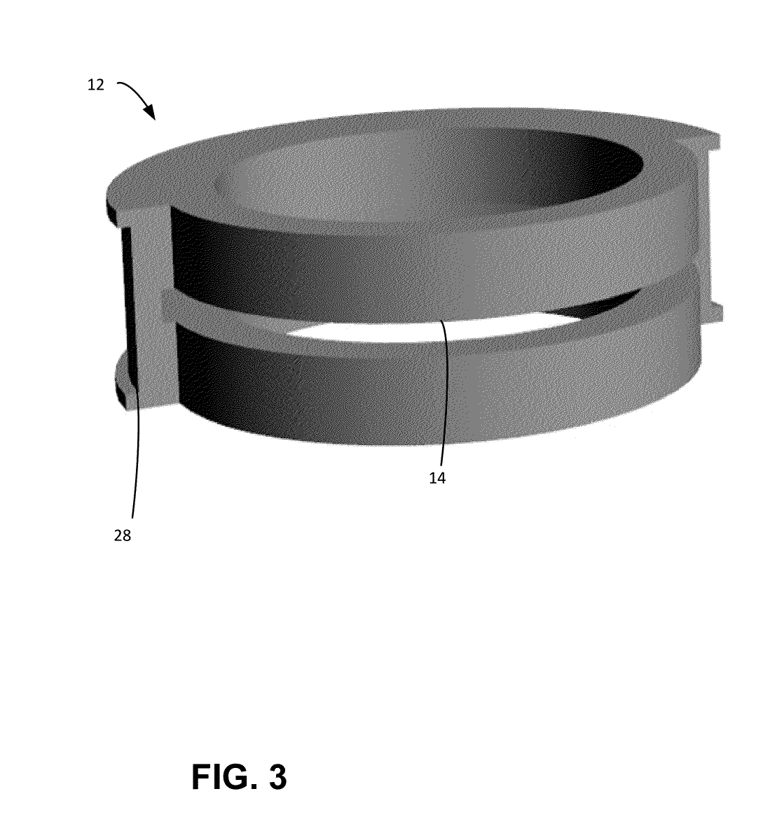

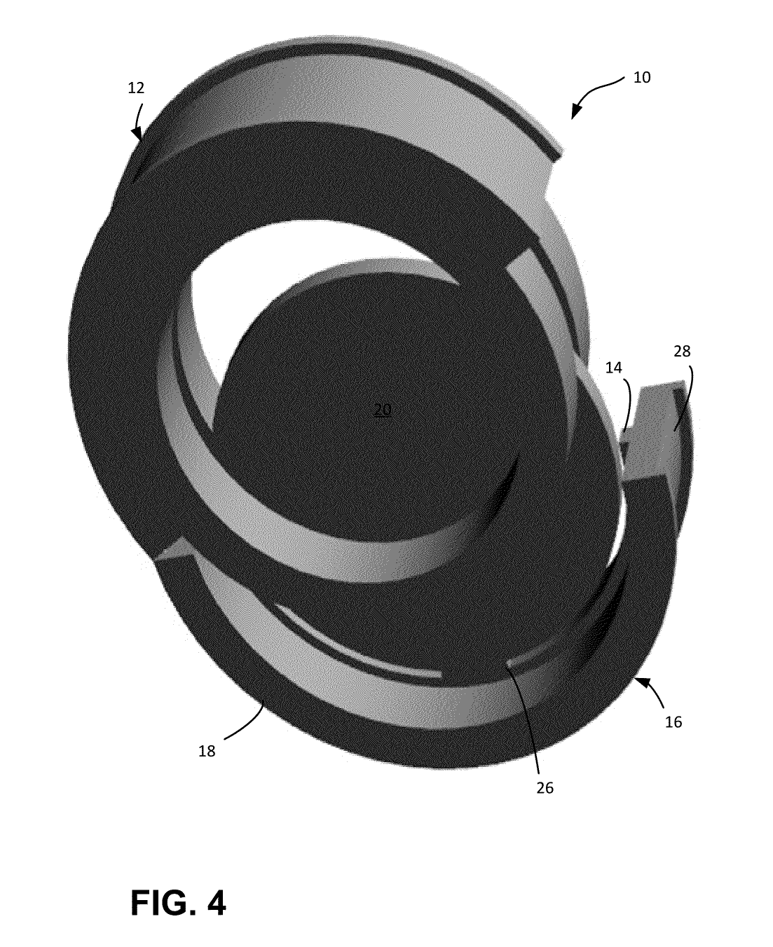

With reference now to FIG. 1, a pipe system 10 is initially described. In one embodiment, the system 10 includes a pipe-junction 12 that is used to join two pieces of pipe together. The pipe-junction 12 additionally includes a mating-surface 14 carried by the pipe-junction. The system 10 also includes a gate 16 that engages the mating-surface 14, and the gate includes an exterior-portion 18 and an interior-portion 20. The system 10 further includes a retainer 22 that secures the gate 16 to the mating-surface 14 during a pressure-test-stage. In other words when retainer 22 secures gate 16, the system 10 can be pressure tested using a fluid such as nitrogen, water, and/or the like to determine if the system 10 has any leaks.

In one embodiment, the system 10 additionally includes a seal 24 (not shown) between the gate 16 and the pipe-junction 12 that fluid-proofs that interface. For instance, the seal 24 comprises gasketing material such as rubber, fiber, silicon, paper, metal, plastic, and/or the like. In another embodiment, the system 10 also includes a frangible joint 26 between the exterior-portion 18 and the interior-portion 20 that enables removal of the interior-portion for a post-test-stage. For example when interior-portion 20 is removed and retainer 22 secures gate 16, fluid can flow through system 10 unimpeded and without leaking out of pipe-junction 12. In addition, interior-portion 20 can be reinserted in to the pipe-junction 12 at any time to permit maintenance, upgrade work, and/or the like.

In another embodiment, the system 10 does not include a frangible joint 26 between the exterior-portion 18 and the interior-portion 20, but instead the mating-surface 14 receives the interior-portion 20 all the way around its perimeter, which includes both the pipe-junction 12 and the exterior-portion 18. In another embodiment, the perimeter is discontinuous in sections.

In one embodiment, the retainer 22 is a band clamp, fastener, adhesive-joint, threaded fastener, clasp, hinge, pin and socket, and/or the like. For instance, when the retainer 22 is a band clamp, it encircles the groove 28. In another embodiment, the gate 16 is not positioned by any mechanical positioning device and is instead positioned within the mating-surface by a user's hand during positioning. For example, the mechanical positioning device is an integral part of the valve and includes screw-actuated designs, power-actuated designs, lever-actuated designs, spring-actuated designs, ball valves, traditional sluice valves, butterfly valves, and/or the like.

In one embodiment, the seal 24 fluid-proofs the interior-portion 20 and the mating-surface 14 interface, and/or the exterior-portion 18 and pipe-junction 12 interface. In another embodiment, the mating-surface 14 includes a relief, an intermittent relief, a raised border, an intermittent raised border, a combination of relief and raised border, and/or the like.

In one embodiment, the retainer 22 seals the pipe-junction 12 when the interior-portion 20 is removed during a post-test-stage. In another embodiment, the pipe-junction 12 comprises a coupler with male and/or female ends (not shown) used to join two pieces of pipe together. In another embodiment, the gate 16 is non-inflatable, which is the opposite of a plumbing test balloon.

In one embodiment, there is no separate gasket in system 10, it's just a mating gasket shape built into the pipe-junction 12 and the interior-portion 20. In another embodiment, the pipe-junction 12 and/or the interior-portion 20 have a gasketing material applied to at least their mating surfaces.

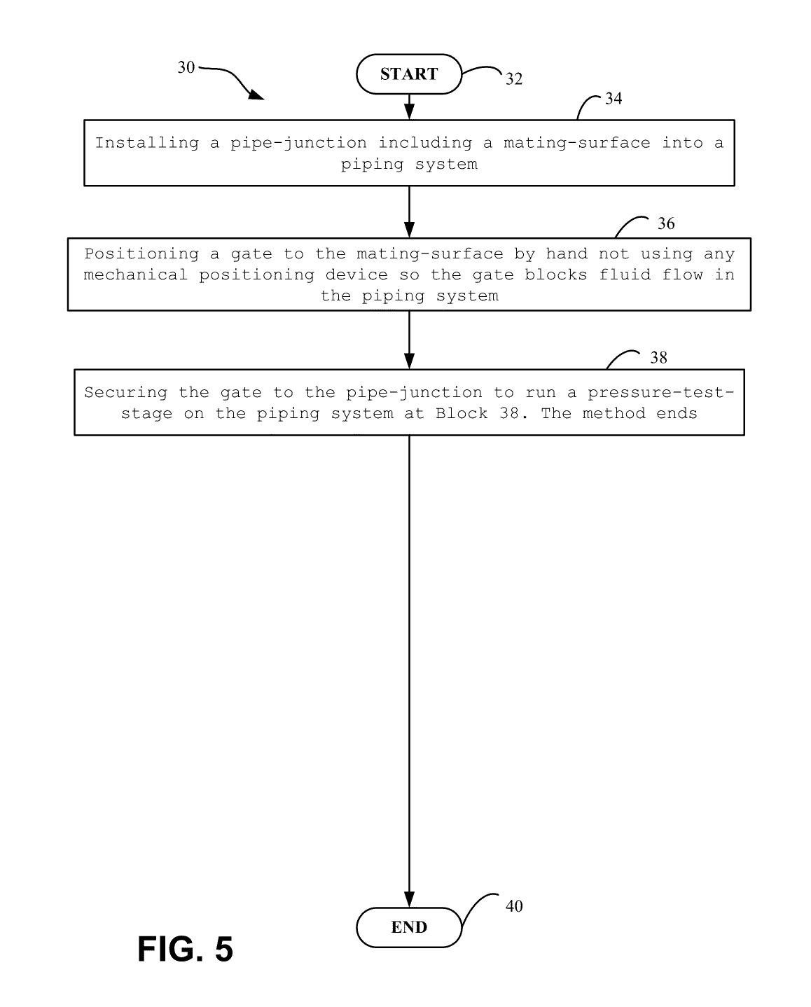

Another aspect is a method, which is now described with reference to flowchart 30 of FIG. 5. The method begins at Block 32 and may include installing a pipe-junction including a mating-surface into a piping system at Block 34. The method may also include positioning a gate to the mating-surface by hand not using any mechanical positioning device so the gate blocks fluid flow in the piping system at Block 36. The method may further include securing the gate to the pipe-junction to run a pressure-test-stage on the piping system at Block 38. The method ends at Block 40.

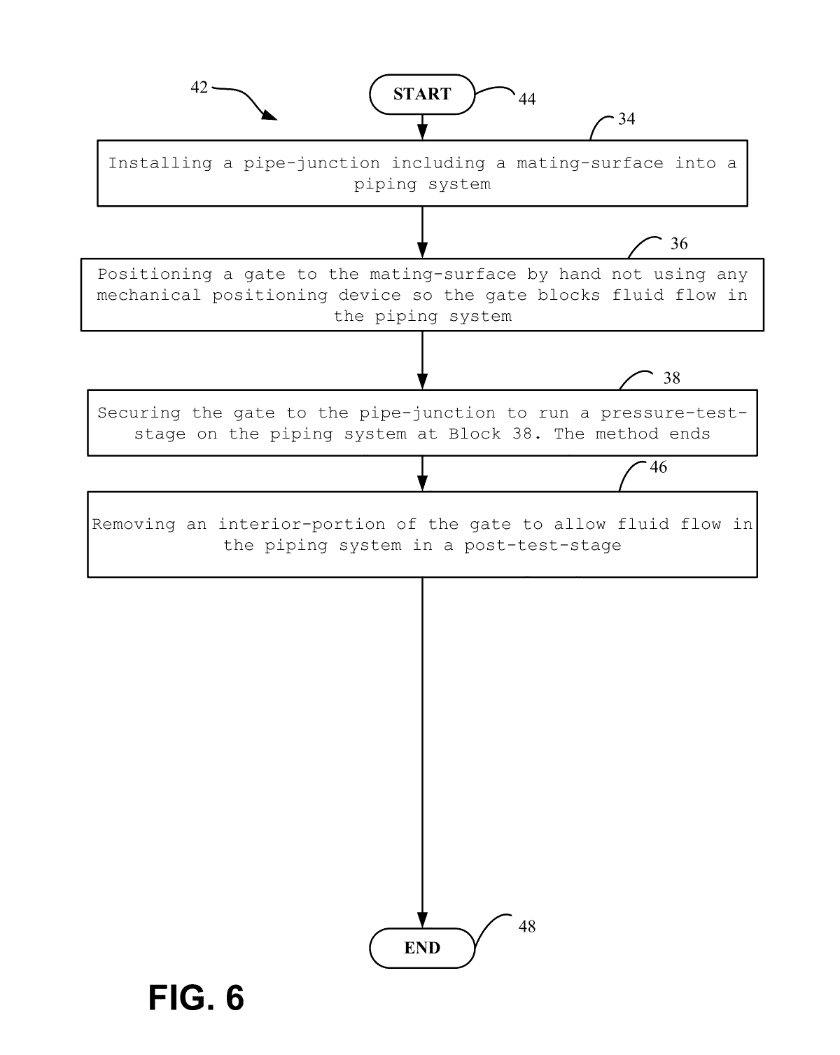

In another method embodiment, which is now described with reference to flowchart 42 of FIG. 6, the method begins at Block 44. The method may include the steps of FIG. 5 at Blocks 34, 36, and 38. The method may additionally include removing an interior-portion of the gate to allow fluid flow in the piping system in a post-test-stage at Block 46. The method ends at Block 48.

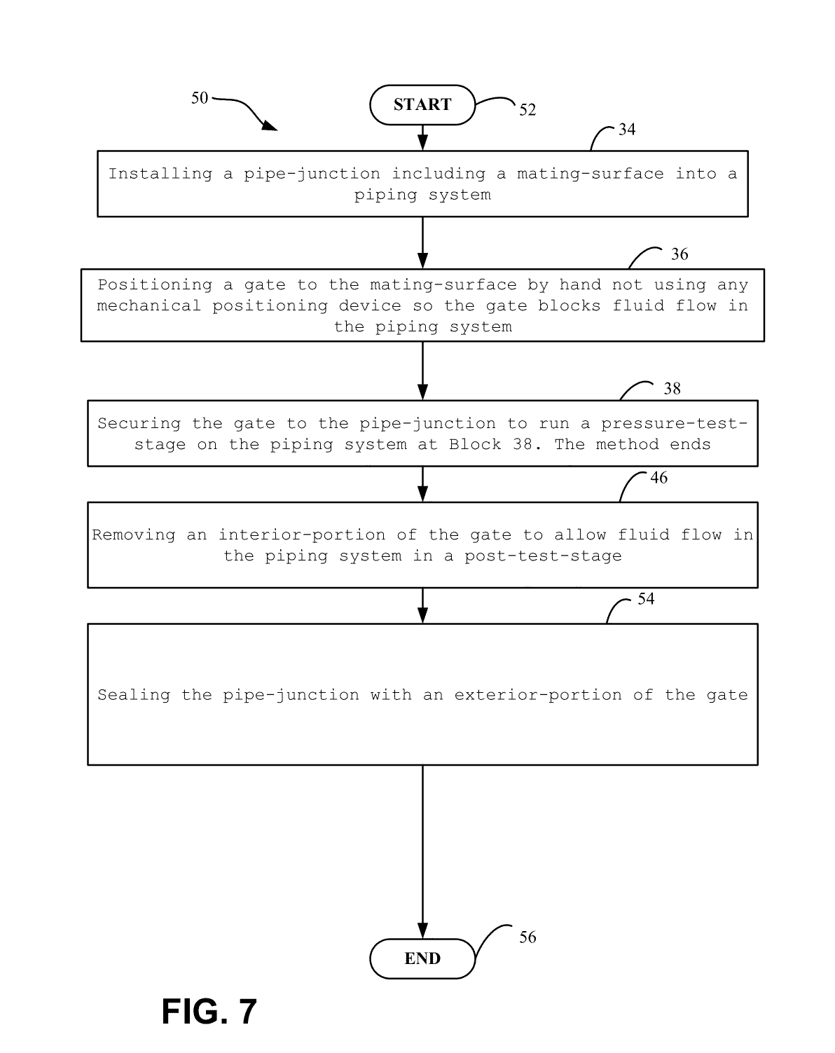

In another method embodiment, which is now described with reference to flowchart 50 of FIG. 7, the method begins at Block 52. The method may include the steps of FIG. 6 at Blocks 34, 36, 38, and 46. The method may additionally include sealing the pipe-junction with an exterior-portion of the gate at Block 54. The method ends at Block 56.

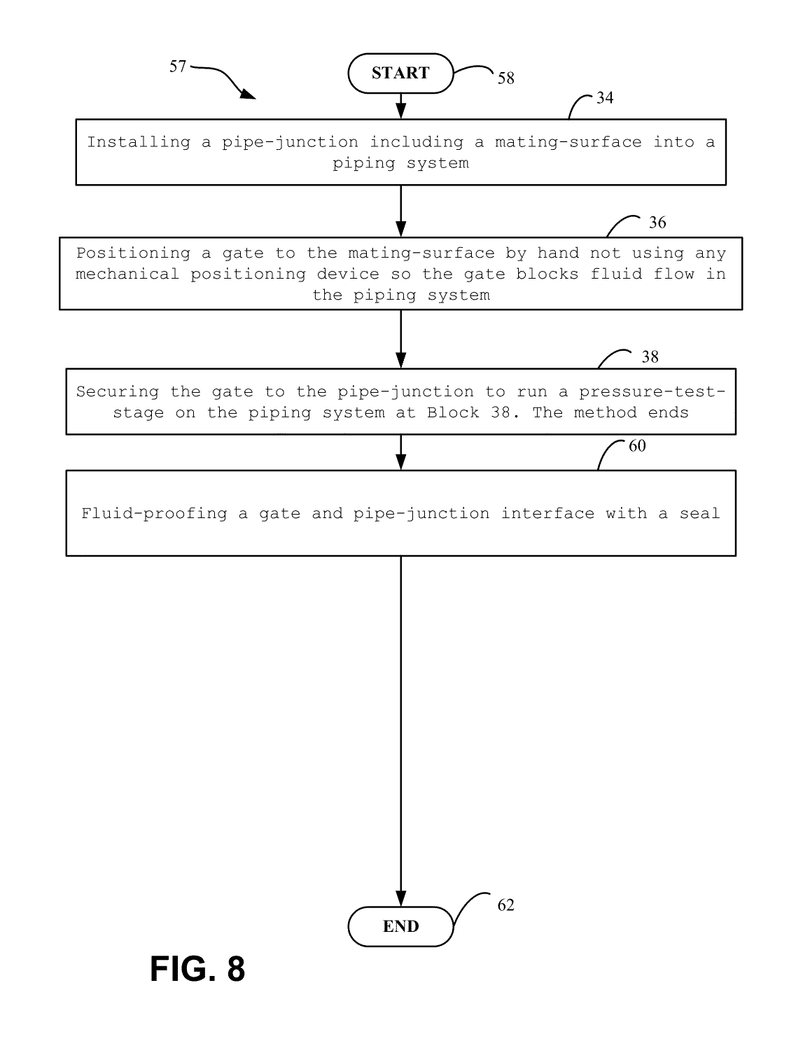

In another method embodiment, which is now described with reference to flowchart 57 of FIG. 8, the method begins at Block 58. The method may include the steps of FIG. 5 at Blocks 34, 36, and 38. The method may additionally include fluid-proofing a gate and pipe-junction interface with a seal at Block 60. The method ends at Block 62.

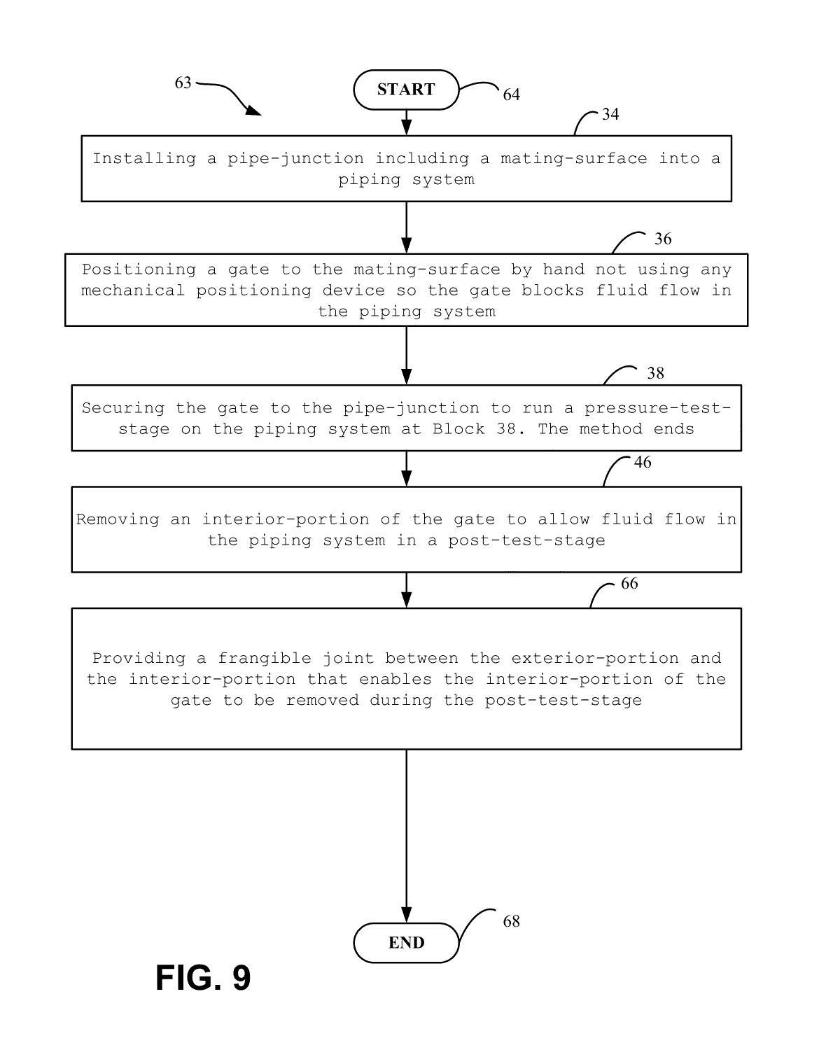

In another method embodiment, which is now described with reference to flowchart 63 of FIG. 9, the method begins at Block 64. The method may include the steps of FIG. 6 at Blocks 34, 36, 38, and 46. The method may additionally include providing a frangible joint between the exterior-portion and the interior-portion that enables the interior-portion of the gate to be removed during the post-test-stage at Block 66. The method ends at Block 68.

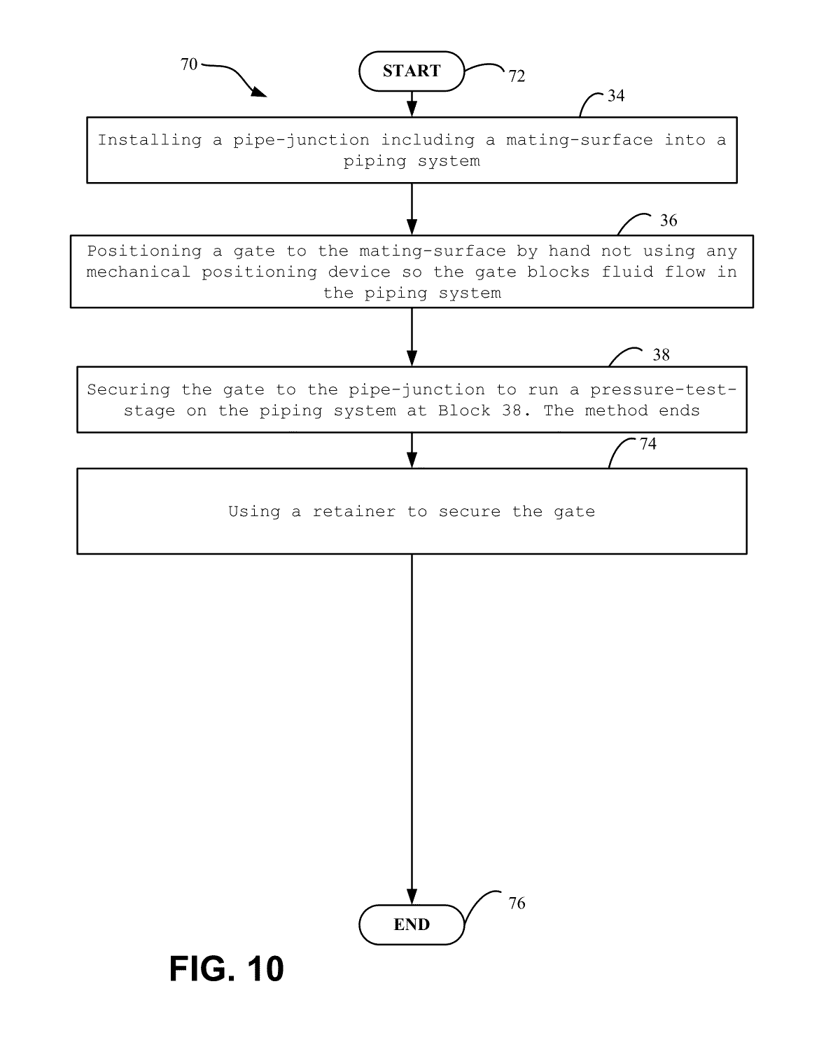

In another method embodiment, which is now described with reference to flowchart 70 of FIG. 10, the method begins at Block 72. The method may include the steps of FIG. 5 at Blocks 34, 36, and 38. The method may additionally include using a retainer to secure the gate at Block 74. The method ends at Block 76.

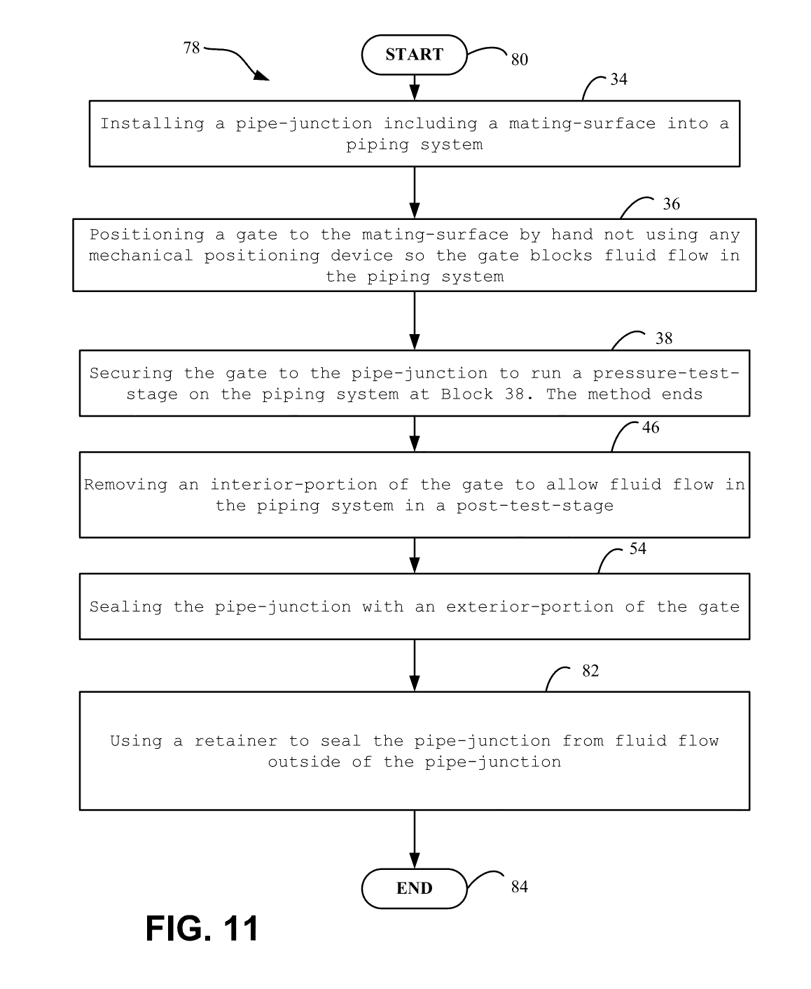

In another method embodiment, which is now described with reference to flowchart 78 of FIG. 11, the method begins at Block 80. The method may include the steps of FIG. 7 at Blocks 34, 36, 38, and 54. The method may additionally include using a retainer to seal the pipe-junction from fluid flow outside of the pipe-junction at Block 82. The method ends at Block 84.

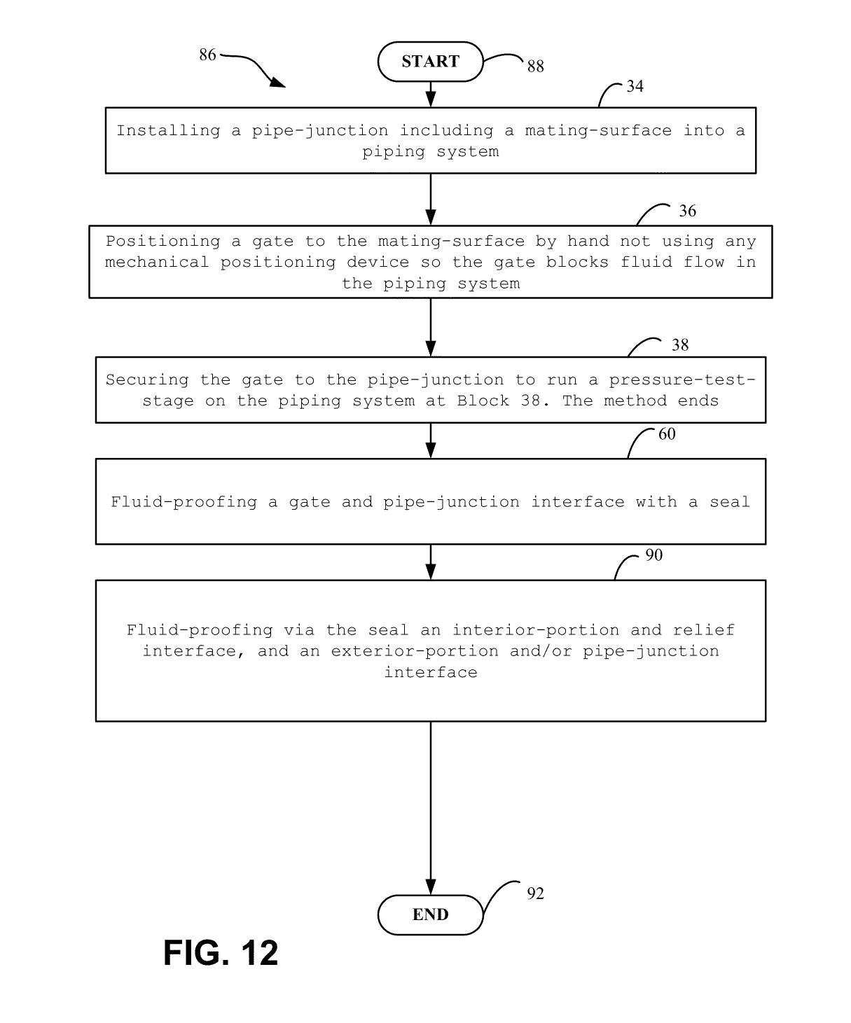

In another method embodiment, which is now described with reference to flowchart 86 of FIG. 12, the method begins at Block 88. The method may include the steps of FIG. 8 at Blocks 34, 36, 38, and 60. The method may additionally include fluid-proofing via the seal an interior-portion and relief interface, and an exterior-portion and/or pipe-junction interface at Block 90. The method ends at Block 92.

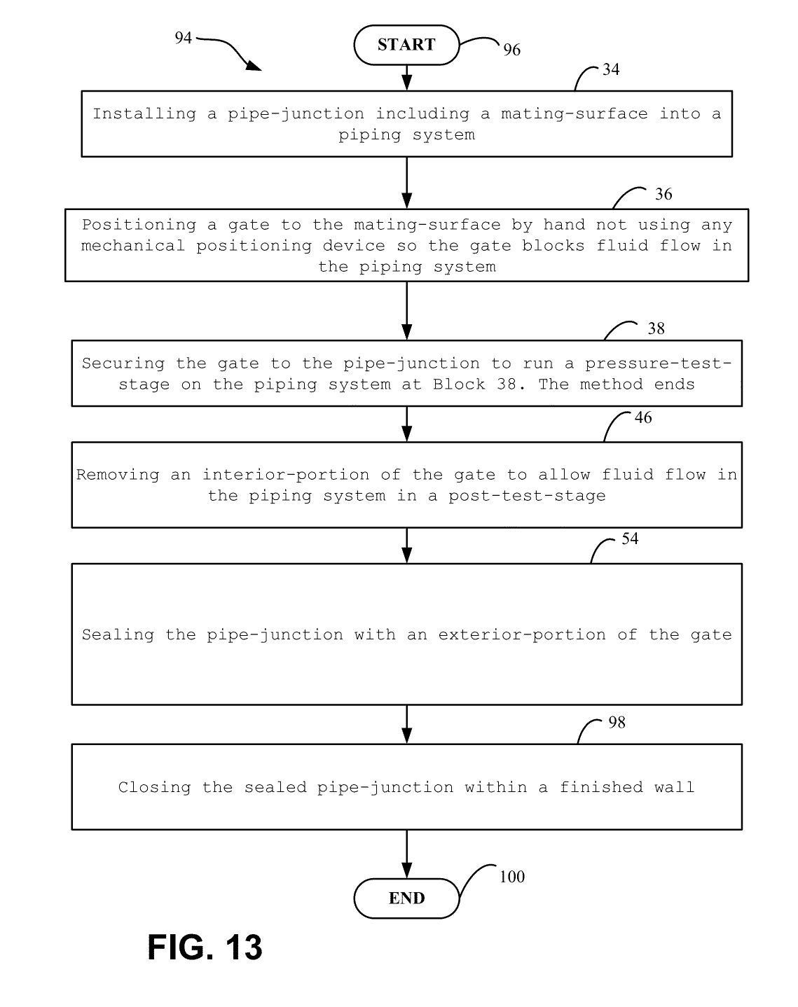

In another method embodiment, which is now described with reference to flowchart 94 of FIG. 13, the method begins at Block 96. The method may include the steps of FIG. 7 at Blocks 34, 36, 38, and 54. The method may additionally include closing the sealed pipe-junction within a finished wall at Block 98. The method ends at Block 100. In other words, the pipe-junction is dimensionally similar to a traditional pipe coupling and is also employed as such.

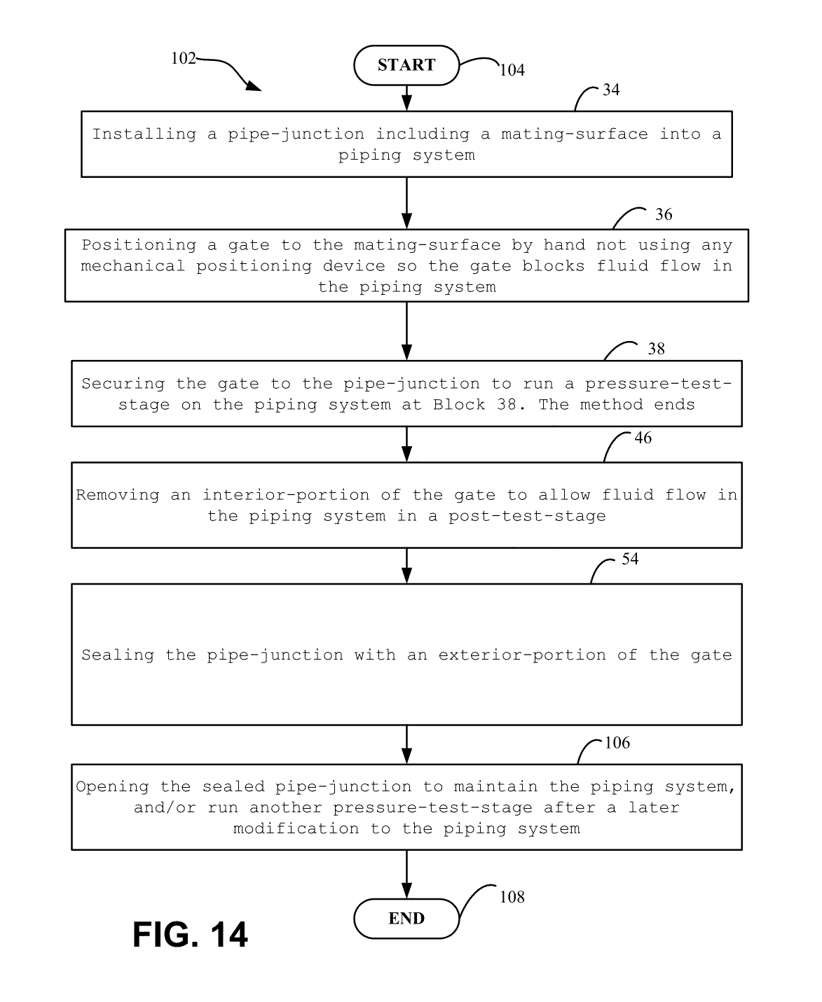

In another method embodiment, which is now described with reference to flowchart 102 of FIG. 14, the method begins at Block 104. The method may include the steps of FIG. 7 at Blocks 34, 36, 38, and 54. The method may additionally include opening the sealed pipe-junction to maintain the piping system, and/or run another pressure-test-stage after a later modification to the piping system at Block 106. The method ends at Block 108.

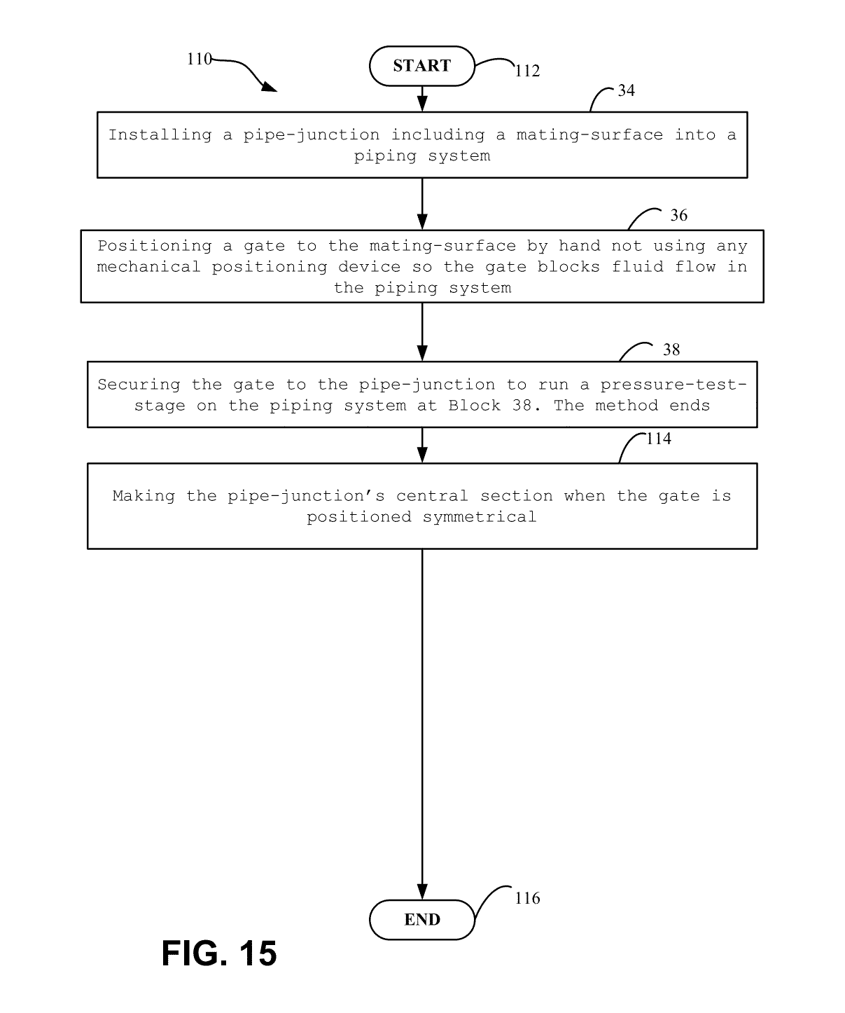

In another method embodiment, which is now described with reference to flowchart 110 of FIG. 15, the method begins at Block 112. The method may include the steps of FIG. 5 at Blocks 34, 36, and 38. The method may additionally include making the pipe-junction's central section when the gate is positioned symmetrical at Block 114. The method ends at Block 118. Stated another way, there is no bulge as is found in traditional gate-valves because there is no mechanical actuator.

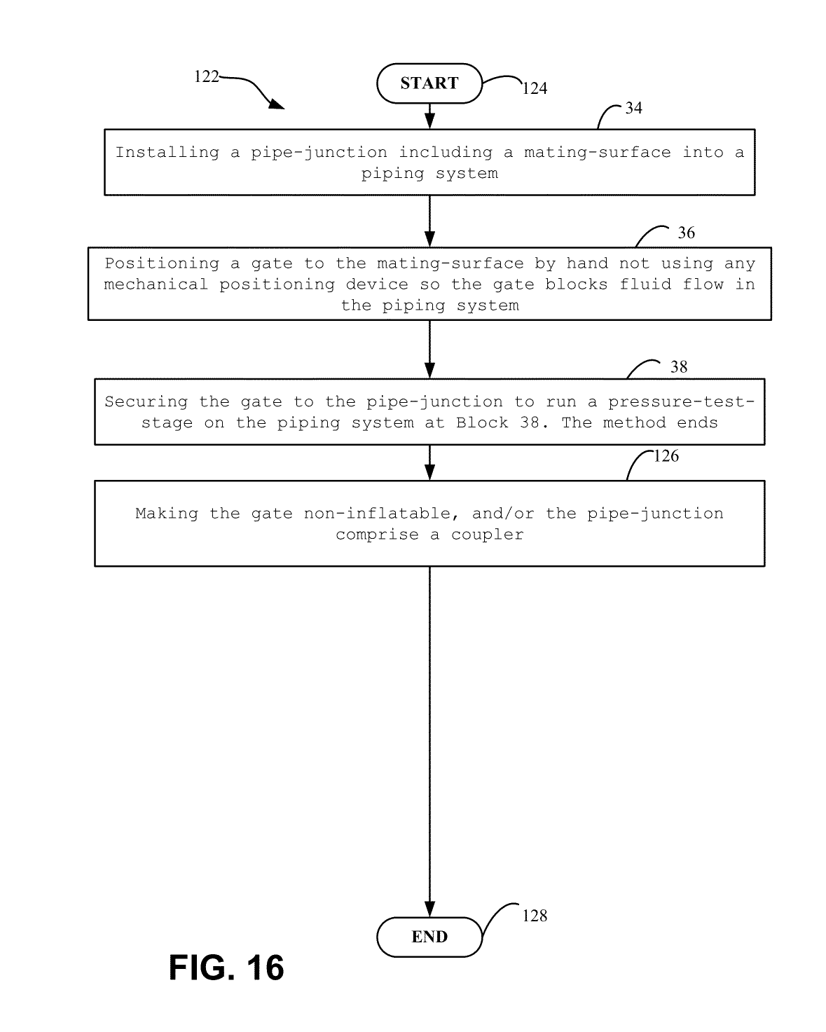

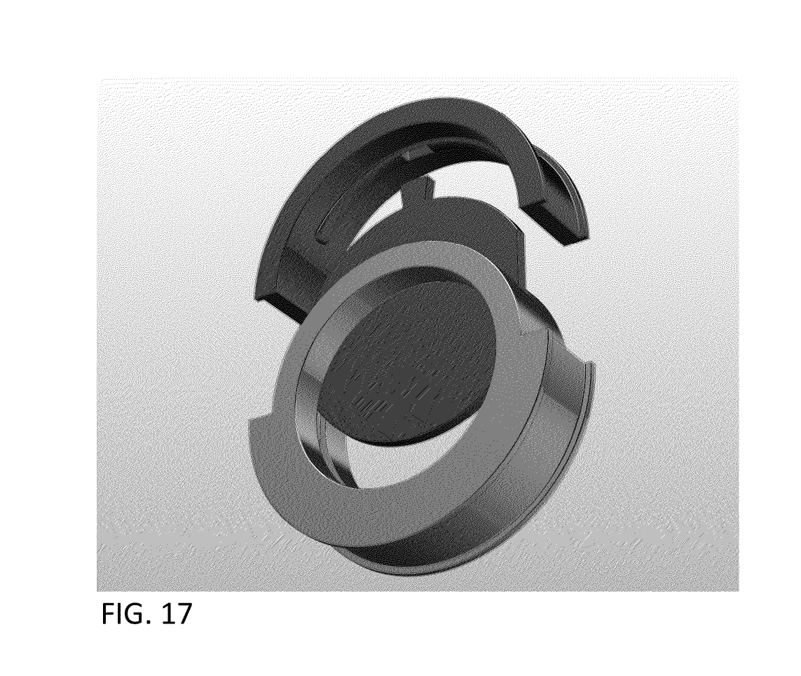

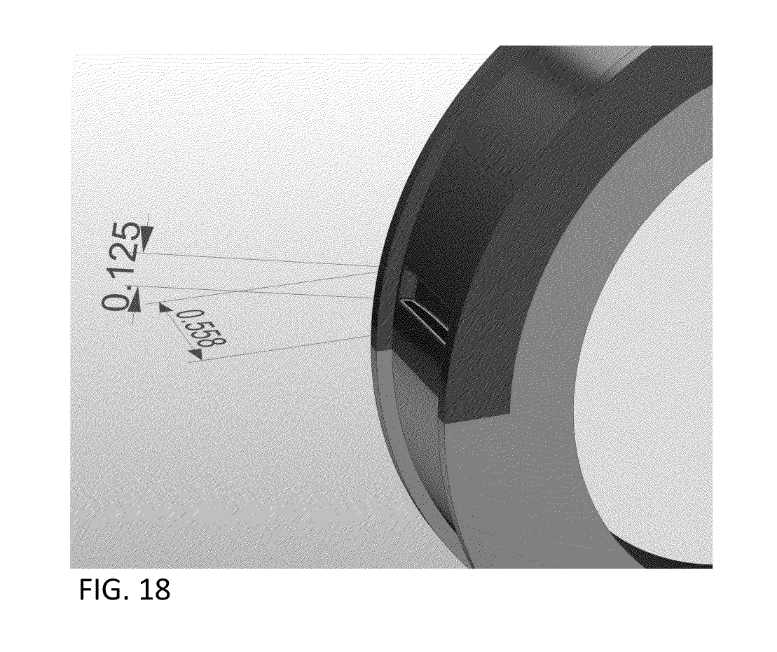

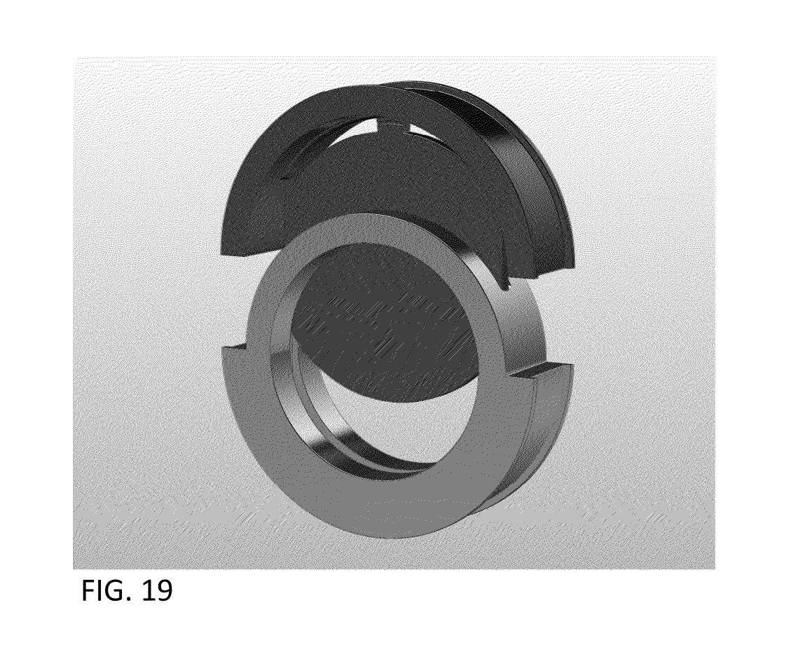

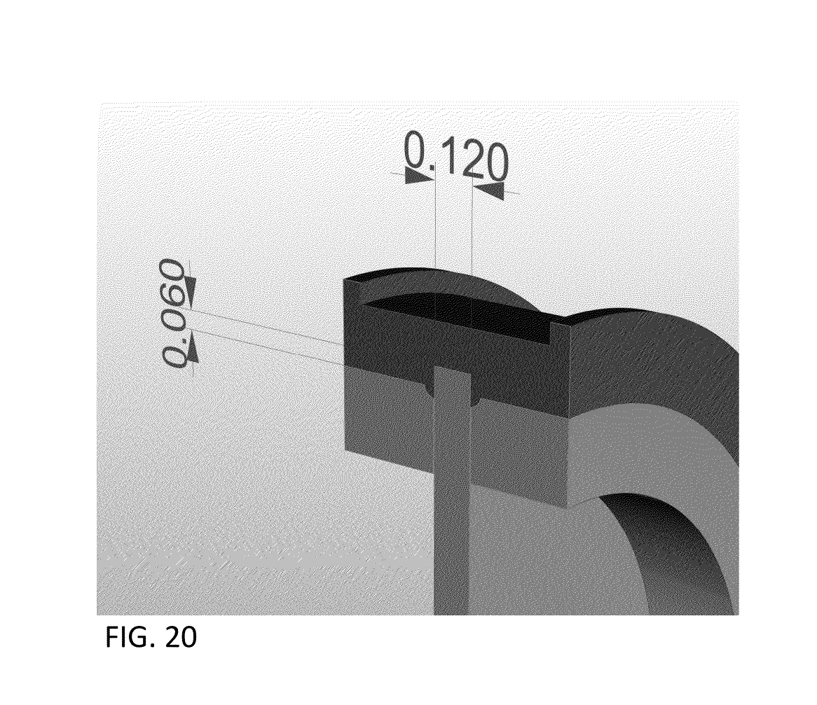

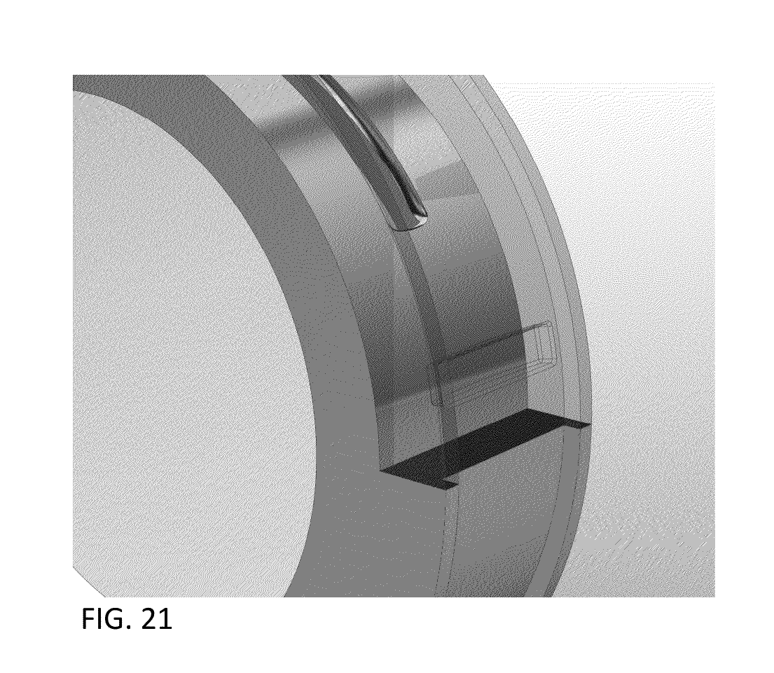

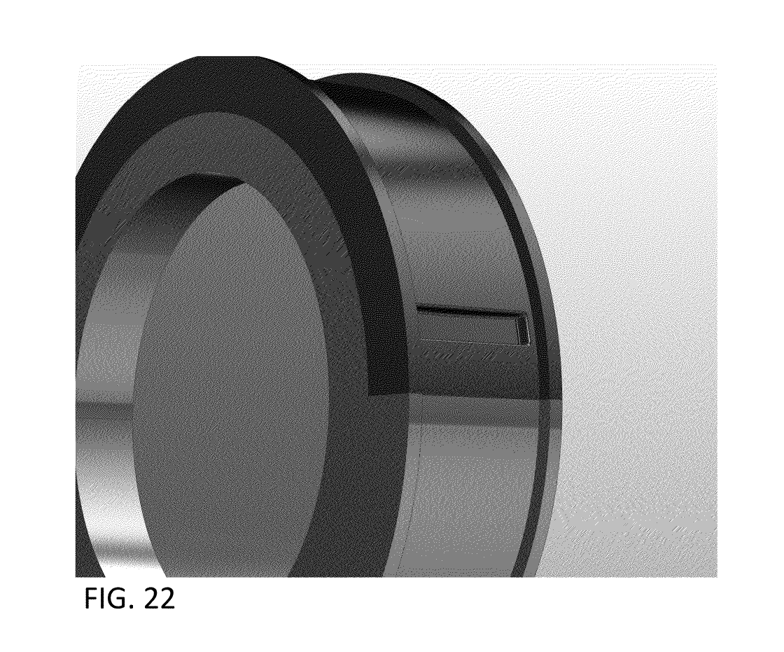

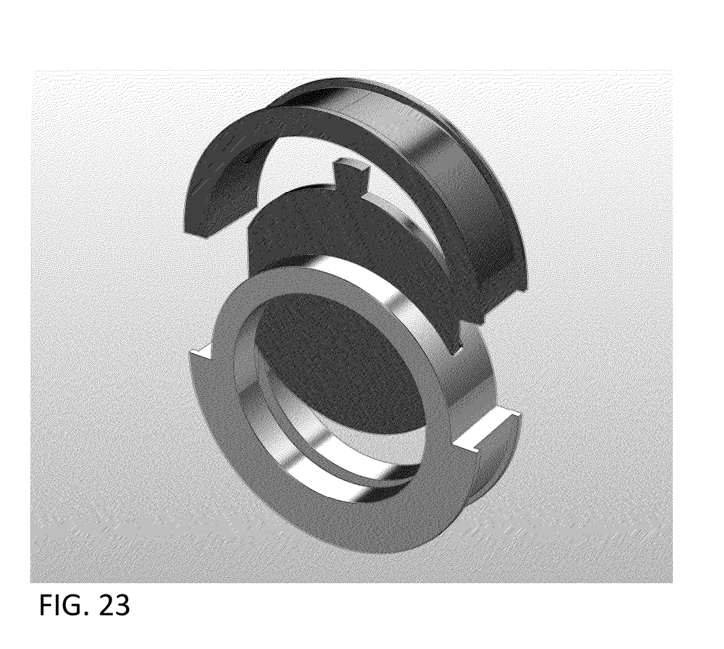

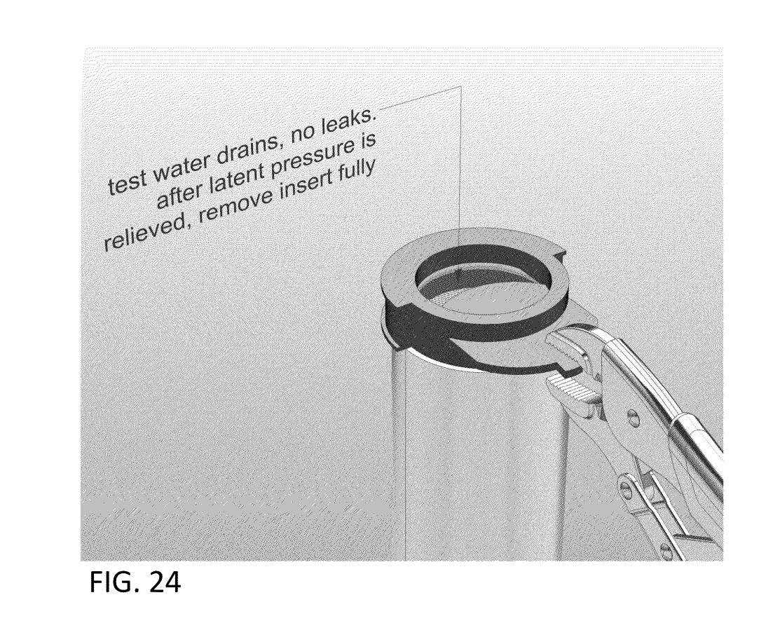

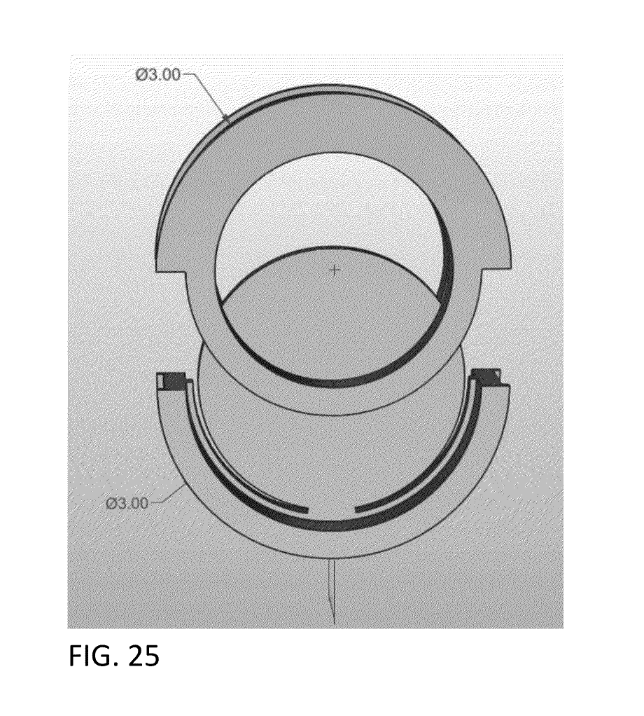

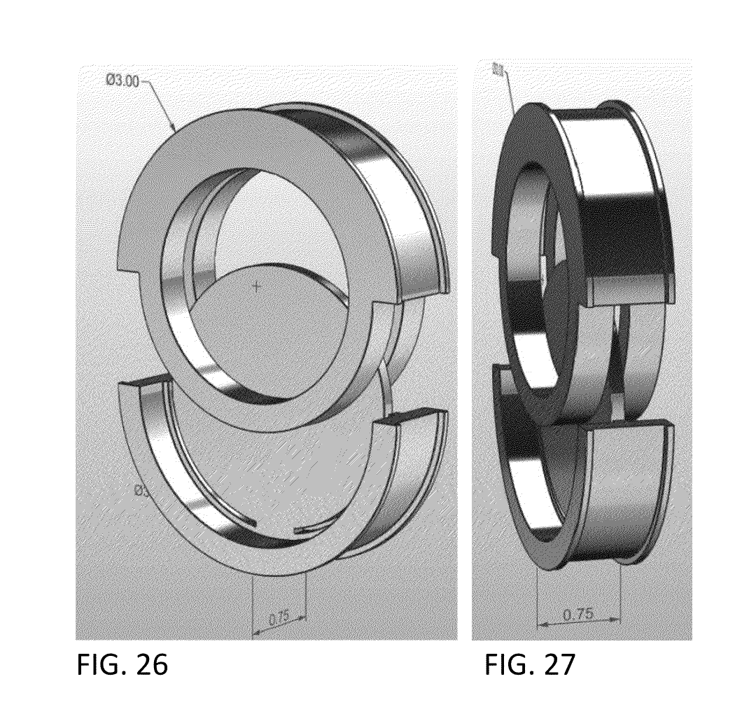

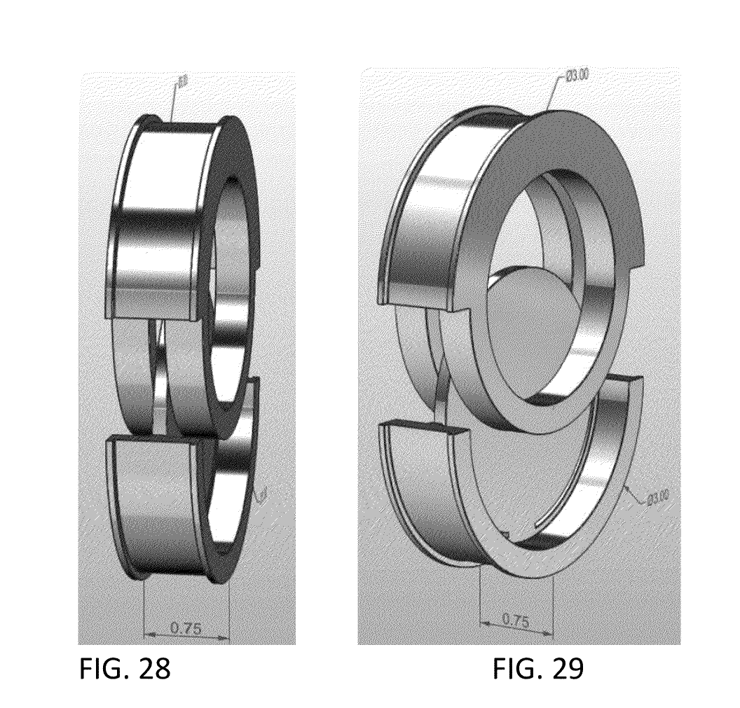

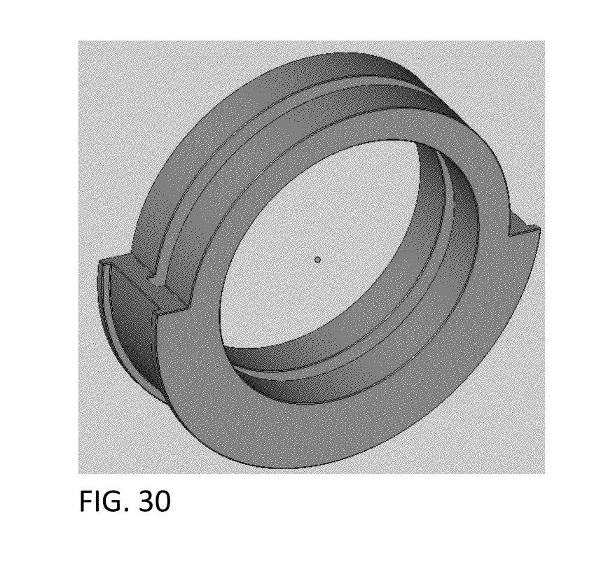

In another method embodiment, which is now described with reference to flowchart 120 of FIG. 16, the method begins at Block 124. The method may include the steps of FIG. 5 at Blocks 34, 36, and 38. The method may additionally include making the gate non-inflatable, and/or the pipe-junction comprise a coupler at Block 126. The method ends at Block 128.

The system 10 provides a one-step test method. In other words, there is no need for test ball plugs that are traditionally used to pressure test an installed piping systems. As there are no test ball plugs necessary the system 10 is ready for test upon installation. Stated another way, there are no additional products needed for a pressure test such as test ball plugs, e.g. balloons, T-valves, tire pumps, and/or the like. As a result, there are no balloons to fail during a test, no to minimal water spillage at test release, and less costly materials and labor.

For example, there are labor savings over the traditional method because there is no inflatable plug to install, removal, and/or because there is also a permanent plug installed when the system 10 is installed. In addition, there is no need to carry around additional plugs balloons, tire pumps, and/or the like from job site to job site.

The system 10 has many applications such as traditional waste and vent systems, ABS plastic systems, PVC plastic systems, No-Hub cast iron systems, ABS/PVC transition to No-Hub cast iron systems, and/or the like.

As will be appreciated by one skilled in the art, aspects may be embodied as a system and/or method. The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments has been presented for purposes of illustration and description, but is not intended to be exhaustive or limited to the embodiments in the form disclosed. Many modifications and variations will be apparent to those of ordinary skill in the art without departing from the scope and spirit of the embodiments. The embodiment was chosen and described in order to best explain the principles of the embodiments and the practical application, and to enable others of ordinary skill in the art to understand the various embodiments with various modifications as are suited to the particular use contemplated.

While the preferred embodiment has been described, it will be understood that those skilled in the art, both now and in the future, may make various improvements and enhancements which fall within the scope of the claims which follow. These claims should be construed to maintain the proper protection for the embodiments first described.

Aspects of the embodiments are described above with reference to flowchart illustrations and/or block diagrams of methods and systems (apparatus) according to the embodiments. The flowchart and block diagrams in the Figures illustrate the architecture, functionality, and operation of possible implementations of systems and methods according to various embodiments. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments has been presented for purposes of illustration and description, but is not intended to be exhaustive or limited to the embodiments in the form disclosed. Many modifications and variations will be apparent to those of ordinary skill in the art without departing from the scope and spirit of the embodiments. The embodiment was chosen and described in order to best explain the principles of the embodiments and the practical application, and to enable others of ordinary skill in the art to understand the various embodiments with various modifications as are suited to the particular use contemplated.

While the preferred embodiment has been described, it will be understood that those skilled in the art, both now and in the future, may make various improvements and enhancements which fall within the scope of the claims which follow. These claims should be construed to maintain the proper protection for the embodiments first described.

What is claimed is:

1. A system comprising:
a pipe-junction;
a mating-surface carried by the pipe-junction;
a gate that engages the mating-surface, the gate includes an exterior-portion and an interior-portion; and
a retainer that secures the gate to the mating-surface during a pressure-test-stage.

2. The system of claim 1 further comprising a seal between the gate and the pipe-junction that fluid-proofs that interface.

3. The system of claim 1 further comprising a frangible joint between the exterior-portion and the interior-portion that enables removal of the interior-portion for a post-test-stage.

4. The system of claim 1 wherein the retainer comprises at least one of a band clamp, fastener, adhesive joint, threaded fastener, clasp, hinge, and pin and socket.

5. The system of claim 1 wherein the gate is not positioned by any mechanical positioning device and is instead positioned within the mating-surface by a user's hand during positioning.

6. The system of claim 2 wherein the seal fluid-proofs at least one of the interior-portion and mating-surface interface, and the exterior-portion and pipe-junction interface.

7. The system of claim 1 wherein the mating-surface includes at least one of a relief, an intermittent relief, a raised border, an intermittent raised border, and a combination of relief and raised border.

8. The system of claim 1 wherein the retainer seals the pipe-junction when the interior-portion is removed during a post-test-stage.

9. The system of claim 1 wherein at least one of the pipe-junction comprises a coupler and the gate is non-inflatable.

10. A method comprising:
installing a pipe-junction including a mating-surface into a piping system;
positioning a gate to the mating-surface by hand not using any mechanical positioning device so the gate blocks fluid flow in the piping system; and
securing the gate to the pipe-junction to run a pressure-test-stage on the piping system.

11. The method of claim 10 further comprising at least one of:
removing an interior-portion of the gate to allow fluid flow in the piping system in a post-test-stage;
fluid-proofing via the seal by at least one of an interior-portion and relief interface, and an exterior-portion and pipe-junction interface; and
fluid-proofing a gate and pipe-junction interface with a seal.

12. The method of claim 11 further comprising sealing the pipe-junction with an exterior-portion of the gate.

13. The method of claim 11 further comprising providing a frangible joint between the exterior-portion and the interior-portion that enables the interior-portion of the gate to be removed during the post-test-stage.

14. The method of claim 10 further comprising using a retainer to secure the gate.

15. The method of claim 12 further comprising using a retainer to seal the pipe-junction from fluid flow outside of the pipe-junction.

16. The method of claim 12 further comprising closing the sealed pipe-junction within a finished wall.

17. The method of claim 12 further comprising opening the sealed pipe-junction to at least one of maintain the piping system, and run another pressure-test-stage after a later modification to the piping system.

18. The method of claim 10 further comprising making the pipe-junction's central section when the gate is positioned symmetrical.

19. The method of claim 10 further comprising making at least one of the gate non-inflatable, and the pipe-junction comprise a coupler.

20. A system comprising:
a pipe-junction that comprises a coupler;
a mating-surface carried by the pipe-junction;
a gate that engages the mating-surface, the gate includes an exterior-portion and an interior-portion, and the gate is non-inflatable;
a retainer that secures the gate to the mating-surface during a pressure-test-stage; and
a seal between the gate and the pipe-junction that fluid-proofs that interface.
